(19) United States
(12) Patent Application Publication
(10) Pub. No.: US 2023/0298095 A1
(43) Pub. Date: Sep. 21, 2023

(54) SELF-SOVEREIGN CREDIT TOKEN ISSUANCE

(71) Applicant: International Business Machines Corporation, Armonk, NY (US)

(72) Inventors: Nitin Gaur, Round Rock, TX (US); Petr Novotny, Mount Kisco, NY (US); Qi Zhang, West Harrison, NY (US)

(21) Appl. No.: 17/655,041

(22) Filed: Mar. 16, 2022

(51) Int. Cl. G06Q 40/02

(52) U.S. Cl. CPC G06Q 40/025

(57) ABSTRACT

In an approach for creating self-sovereign credit token issuance to facilitate account to account lending and creation of a digital credit market, a processor identifies a digital interaction within an edge of connected accounts, wherein the digital interaction includes an account-to-account transaction having a total economic impact within the edge of connected accounts. A processor evaluates, based on the digital interaction, potential future earnings of a fungible token and a non-fungible token. A processor provides a criterion to generate a self-sovereign, self-issued credit token that is embedded with a credit worthiness of the self-sovereign, self-issued credit token, based on the total economic impact and the potential future earnings.

### BACKGROUND

The present disclosure relates generally to the field of a blockchain and decentralized finance network, and more particularly to creating self-sovereign credit token issuance to facilitate account to account lending and creation of a digital credit market.

Establishing liquidity between the traditional banking system and decentralized applications that leverage stable tokens is essential for mainstream adoption of blockchain-based payment technologies. A decentralized, mobile payment system would ultimately eliminate overdraft fees because over-drafting funds on the blockchain is difficult or impossible. A blockchain may be a system of recording information in a way that makes it difficult or impossible to change, hack, or cheat the system. A blockchain may be a digital ledger of transactions that is duplicated and distributed across the entire network of computer systems on the blockchain. Each block in the chain contains a number of transactions. Every time a new transaction occurs on the blockchain, a record of that transaction may be added to every participant's ledger. In a blockchain, fungible tokens are cryptocurrencies like Bitcoin. Nonfungible tokens are units of data that represent a unique digital asset stored and verified on the blockchain. Utility tokens may give holders access to products and services that are blockchain-based. Security tokens may be traditional assets like stocks and shares represented by digital tokens on the blockchain. Fungible tokens or assets may be divisible and non-unique. Nonfungible tokens or assets, on the other hand, may be unique and non-divisible. For example, nonfungible tokens can be considered as a type of deed or title of ownership of a unique, non-replicable item. Nonfungible tokens, which represent one unique and indivisible item—physical or intangible—like a picture or intellectual property. Nonfungible tokens can be created and stored in a public blockchain that is open and accessible to anyone. Blockchain can be the underlying technology that can easily prove ownership of an intangible digital item.

### SUMMARY

Aspects of an embodiment of the present disclosure disclose an approach for creating self-sovereign credit token issuance to facilitate account to account lending and creation of a digital credit market. A processor identifies a digital interaction within an edge of connected accounts, wherein the digital interaction includes an account-to-account transaction having a total economic impact within the edge of connected accounts. A processor evaluates, based on the digital interaction, potential future earnings of a fungible token and a non-fungible token. A processor provides a criterion to generate a self-sovereign, self-issued credit token that is embedded with a credit worthiness of the self-sovereign, self-issued credit token, based on the total economic impact and the potential future earnings.

### BRIEF DESCRIPTION OF THE DRAWINGS

FIG. 1 is a functional block diagram illustrating a self-sovereign token issuance environment, in accordance with an embodiment of the present disclosure.

FIG. 2 is a flowchart depicting operational steps of a self-sovereign token issuance module within a computing device of FIG. 1, in accordance with an embodiment of the present disclosure.

FIG. 3 illustrates an exemplary wallet on various blockchains of an exemplary functional diagram of the self-sovereign token issuance module within the computing device of FIG. 1, in accordance with an embodiment of the present disclosure.

FIG. 4 illustrates an exemplary functional diagram of an asset classification module within the computing device of FIG. 1, in accordance with an embodiment of the present disclosure.

FIG. 5 illustrates an exemplary functional diagram of the self-sovereign token issuance module within the computing device of FIG. 1, in accordance with an embodiment of the present disclosure.

FIG. 6 is a block diagram of components of the computing device of FIG. 1, in accordance with an embodiment of the present disclosure.

### DETAILED DESCRIPTION

The present disclosure is directed to systems and methods for creating self-sovereign credit token issuance to facilitate account to account lending and creation of a digital credit market.

Embodiments of the present disclosure recognize a need for facilitating non-custodial finance in a blockchain and decentralized network. Embodiments of the present disclosure recognize a need for facilitating an ecosystem which may replace intermediaries, e.g., banks and financial institutions. Embodiments of the present disclosure recognize a need for facilitating a model that may use digital interactions and assets potential for future earnings as an instrument to issue a personal credit to raise funds, borrow money and facilitate lending for an account holder (e.g., an individual or an institution). For example, in the ecosystem with custodial and non-custodial finance, an account holder may have a digital wallet which may access to a digital marketplace. The digital marketplace may include diverse asset classes in various valuation mechanism employed by, for example, individuals, decentralized finance entities or institutions.

Embodiments of the present disclosure disclose creating a self-sovereign credit token issuance to facilitate account to account lending and creation of digital credit markets. Embodiments of the present disclosure disclose taking stock of all digital interactions such as account to account transactions including asset exchange and issuance of IOUs (I owe You) and total economic impact with a edge of connected accounts. An IoU may be a written, but largely informal, acknowledgement that a debt exists between two parties, and the amount the borrower owes the lender. Embodiments of the present disclosure disclose evaluating digital potential of future earnings from, e.g., fungible tokens, utility tokens and non-fungible tokens. Embodiments of the present disclosure disclose evaluating potential earnings and values from nontransferable non-fungible tokens, e.g., a health care record, a driving history document, and a user-based insurance. Embodiments of the present disclosure disclose using a model technique to provide a criterion to generate a self-sovereign credit token issuance which may be embedded with a credit worthiness of the self-sovereign, self-issued credit token. Embodiments of the present disclosure disclose creating a self-sovereign credit token issuance to facilitate account to account lending and creation of digital credit markets by incorporating digital entities involved in the decentralized finance.

Embodiments of the present disclosure disclose a custodial or non-custodial account which may represent a wallet on a blockchain network. The wallet can be a custodian wallet hosted by a third party, or a non-custodial wallet hosted by an account holder that can be an individual or an institution. A wallet may be a part of a blockchain network with access to multiple blockchain networks. Multiple wallets could be represented as a single wallet. Embodiments of the present disclosure disclose an asset class categorization and asset inventory modulator. The asset class categorization and asset inventory modulator may provide representation of multiple wallets as a single wallet. The asset class categorization and asset inventory modulator may ensure registration of all wallets in all blockchain networks. The asset class categorization and asset inventory modulator may provide an inventory of asset classes. The asset class categorization and asset inventory modulator may access evaluation modules (e.g., a third-party service such as an exchange or a decentralized finance market data provider) and a current list of all assets classes including previous issued IOUs, decentralized finance tokens, crypto native assets, utility coins and lending and IOUs of other accounts. The assets may also include fungible tokens, utility tokens, non-fungible tokens and other non-fungible tokens that may provide a vehicle of analysis to lenders and a threshold evaluation.

Embodiments of the present disclosure disclose a self-sovereign token issuance module. Embodiments of the present disclosure disclose issuing a self-sovereign credit token that may provide a docket credential to the token issued. Embodiments of the present disclosure disclose issuing a self-sovereign token when the total economic impact is net positive, e.g., sufficient collateral and credit worthiness. Embodiments of the present disclosure disclose issuing a self-sovereign token when the potential future earning is factored in to induce a notion on ability to repay against the credit credential. Upon issuance of a self-sovereign credit token, a docket credential may be appended to the token that includes the total economic impact and potential future earnings ratio for the lenders. If both the total economic impact and potential future earnings are negative, then a token is not generated. Embodiments of the present disclosure disclose issuing a self-sovereign token on a specific chain and updating an asset class categorization and asset inventory module to reflect the credit upon the transaction validation. The docket credential may be updated on the transaction finality. Embodiments of the present disclosure disclose providing transparent evaluation by computing the potential valuation, collateralization, potential future earning and total economic impact on personal creditworthiness.

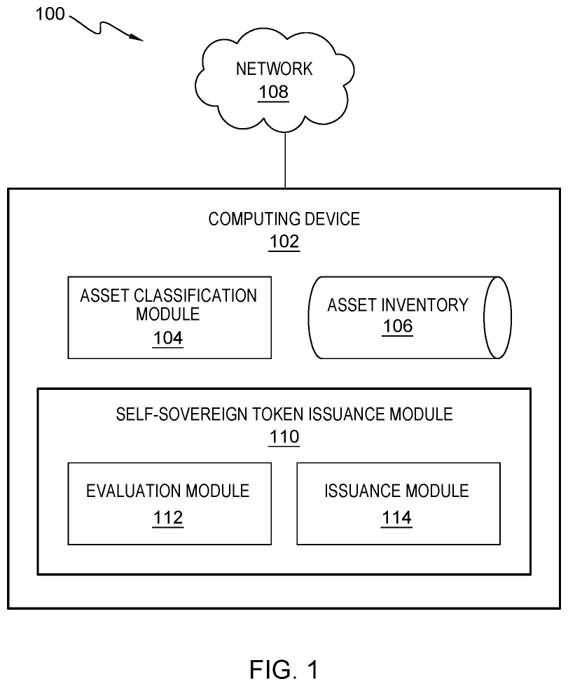

The present disclosure will now be described in detail with reference to the Figures. FIG. 1 is a functional block diagram illustrating a self-sovereign token issuance environment, generally designated 100, in accordance with an embodiment of the present disclosure.

In the depicted embodiment, self-sovereign token issuance environment 100 includes computing device 102 and network 108.

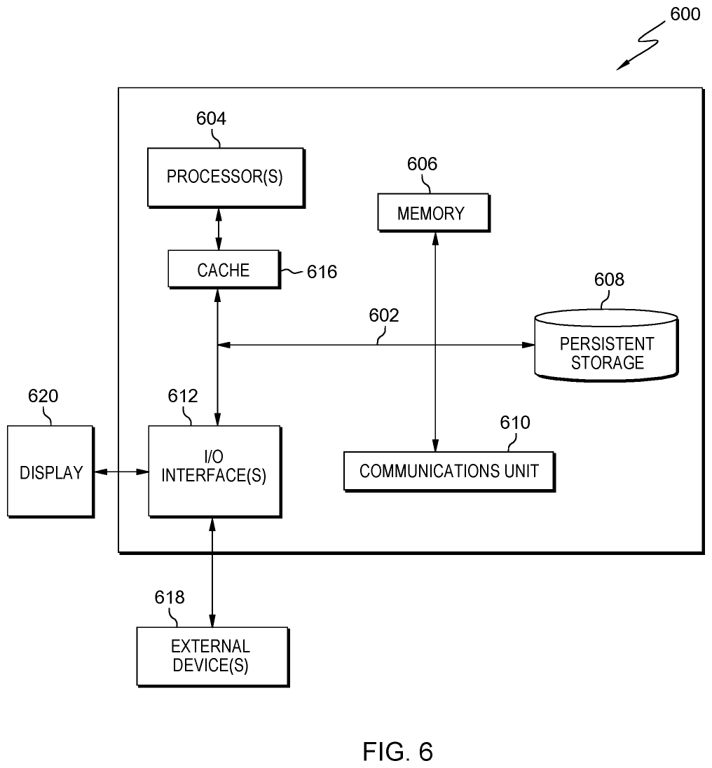

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to self-sovereign token issuance module 110 and network 108 and is capable of processing program instructions and executing self-sovereign token issuance module 110, in accordance with an embodiment of the present disclosure. Computing device 102 may include internal and external hardware components, as depicted and described in further detail with respect to FIG. 6.

Further, in the depicted embodiment, computing device 102 includes asset classification module 104, asset inventory 106 and self-sovereign token issuance module 110. In the depicted embodiment, asset classification module 104, asset inventory 106 and self-sovereign token issuance module 110 are located on computing device 102. However, in other embodiments, asset classification module 104, asset inventory 106 and self-sovereign token issuance module 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and asset classification module 104, asset inventory 106 and self-sovereign token issuance module 110, in accordance with a desired embodiment of the disclosure.

In one or more embodiments, asset classification module 104 is configured to provide an inventory of asset classes in asset inventory 106 in a blockchain network (e.g., network 108). In an example, a blockchain may be a digital ledger of transactions that is duplicated and distributed across the entire network (e.g., network 108) of computer systems on the blockchain. Each block in the chain may contain a number of transactions. Every time a new transaction occurs on the blockchain, a record of that transaction may be added to every participant's ledger.

Asset classification module 104 may classify and provide a current list of all assets classes including previous issued IOUs, DeFi (decentralized finance) tokens, crypto native assets, utility coins, and lending and IoU of other accounts. The asset may also include fungible tokens, utility tokens, and non-fungible tokens, and other non-transferable non-fungible tokens. In an example, an IOU may be a written, but largely informal, acknowledgement that a debt exists between two parties, and the amount the borrower owes the lender. In another example, decentralized finance (DeFi) may be an emerging financial technology based on secure distributed ledgers similar to those used by cryptocurrencies. DeFi may eliminate the fees that banks and other financial companies charge for using their services. Asset classification module 104 may provide access to evaluation modules (e.g., a third-party service such as an exchange or a DeFi market data provider). In an example, tokens in a blockchain may be typically referred to as crypto tokens and may represent digital units of value developed on existing blockchain networks. For example, in a blockchain, fungible tokens may be cryptocurrencies (e.g., bitcoins). Nonfungible tokens may be units of data that represent a unique digital asset stored and verified on the blockchain. There can be tokens for any kind of service or product in the crypto space. Payment tokens, for example, may be coins like bitcoin or litecoin, used to pay for transactions in the digital world. Utility tokens may give holders access to products and services that are blockchain-based. Security tokens may be traditional assets like stocks and shares represented by digital tokens on the blockchain. In an example, fungible tokens or assets may be divisible and non-unique. For instance, fiat currencies like the dollar are fungible. A fungible token can also be a cryptocurrency like bitcoin. Nonfungible tokens or assets, on the other hand, may be unique and non-divisible. Nonfungible tokens may be considered as a type of deed or title of ownership of a unique, non-replicable item. For example, a flight ticket may be nonfungible because there cannot be another of the same kind due to its specific data. A house, a boat or a car may be nonfungible physical assets because they are one-of-a-kind. Nonfungible tokens may be one unique and indivisible item—physical or intangible—like a picture or intellectual property. A blockchain may prove ownership of an intangible digital item. Nonfungible tokens can be created and stored in a public blockchain that is open and accessible to anyone. The items the nonfungible tokens represent may be verifiable and traceable, while the owner can remain anonymous.

Asset classification module 104 may provide representation as a single wallet, which functions to ensure registration of all wallets in all blockchain networks. A wallet can be a representation of a custodial or non-custodial account on a blockchain network. For example, a wallet can be a custodian wallet (e.g., hosted by a third party). In another example, a wallet can be a non-custodial wallet (e.g., hosted by an account holder that can be an individual or an institution). A wallet may be a part of a blockchain network, with access to the blockchain network. In an example, multiple wallets can be represented as a single wallet utilizing asset classification module 104 which can be a multi-wallet asset classification and inventory modulator.

In one or more embodiments, self-sovereign token issuance module 110 is configured to identify a digital interaction within an edge of connected accounts. The digital interaction may include an account-to-account transaction having a total economic impact within the edge of connected accounts. A total economic impact may be potential effects of investments across cost, benefits, flexibility, and risk. A total economic impact may provide a cost and benefit analysis that may incorporate an evaluation of future technology and business flexibility and associated risk. Self-sovereign token issuance module 110 may take stock of all digital interactions including the account-to-account transaction having an asset exchange, an issuance of an IoU, and the total economic total economic impact within the edge of connected accounts. Self-sovereign token issuance module 110 may create a self-sovereign credit token issuance to facilitate an account-to-account lending and creation of a digital credit market. Self-sovereign token issuance module 110 may incorporate all digital entities involved in the decentralized finance. Self-sovereign token issuance module 110 may issue a self-sovereign credit token that provides a credential to the token issued. Self-sovereign token issuance module 110 may provide transparent evaluation by computing the potential valuation, collateralization, potential future earning and total economic impact on personal creditworthiness. Self-sovereign token issuance module 110 may focus on digital activities including the future earning potential of assets based on a user's finance history, spending and investment in a digital realm.

In one or more embodiments, self-sovereign token issuance module 110 is configured to evaluate, based on the digital interaction, a potential future earning of a fungible token and a non-fungible token. In an example, the non-fungible token may be selected from a group consisting of: intellectual property, patent, trademark, trade secret, brand name, artwork, article, stock, and trust. In another example, the non-fungible token may be any other suitable non-fungible tokens. Self-sovereign token issuance module 110 may evaluate the potential future earning of a nontransferable non-fungible token. In an example, the nontransferable non-fungible token may include a health care record, a driving history, and a user-based insurance. In another example, the nontransferable non-fungible token may be any other suitable nontransferable non-fungible tokens. Self-sovereign token issuance module 110 may evaluate digital potential of future earnings such as fungible tokens, utility tokens and non-fungible tokens. Self-sovereign token issuance module 110 may evaluate the potential earnings and value of nontransferable non-fungible tokens such as a health care record, a driving history and a user-based insurance. In an example, non-fungible tokens may include intellect property, patents, trademarks, brands, trust, and other suitable non-fungible tokens. Non-fungible tokens may include assets with a future maturity date, e.g., interests from a saving account.

In one or more embodiments, self-sovereign token issuance module 110 is configured to provide a criterion to generate a self-sovereign, self-issued credit token that is embedded with a credit worthiness of the self-sovereign, self-issued credit token, based on the total economic impact and the potential future earnings. Self-sovereign token issuance module 110 may issue the self-sovereign, self-issued credit token based on the total economic impact and the potential future earnings. Self-sovereign token issuance module 110 may append a credential to the self-sovereign, self-issued credit token that includes a ratio of the total economic impact and the potential future earnings. Self-sovereign token issuance module 110 may update a specific chain and asset inventory 106 to reflect a credit upon a transaction validation and the docket credential updated on a transaction finality. In response to determining that the total economic impact is positive, self-sovereign token issuance module 110 may issue a self-sovereign, self-issued credit token implying sufficient collateral and credit worthiness. In response to determining that the total economic impact is negative, self-sovereign token issuance module 110 may issue a self-sovereign, self-issued credit token based on the potential future earnings factored in to induce a notion on ability to repay against a credit credential. Self-sovereign token issuance module 110 may integrate and evaluate existing sources and history from various networks in generation of a new asset for a user. Self-sovereign token issuance module 110 may not issue a self-sovereign, self-issued credit token if the total economic impact and the potential future earnings are negative. Self-sovereign token issuance module 110 may issue on a specific chain. Self-sovereign token issuance module 110 may update an asset class categorization and asset inventory to reflect the credit upon the transaction validation and the docket credential is updated on a transaction finality.

Further, in the depicted embodiment, self-sovereign token issuance module 110 includes evaluation module 112 and issuance module 114. In the depicted embodiment, evaluation module 112 and issuance module 114 are located on computing device 102 and self-sovereign token issuance module 110. However, in other embodiments, evaluation module 112 and issuance module 114 may be located externally and accessed through a communication network such as network 108.

In one or more embodiments, evaluation module 112 is configured to identify a digital interaction within an edge of connected accounts. The digital interaction may include an account-to-account transaction having a total economic impact within the edge of connected accounts. Evaluation module 112 may take stock of all digital interactions including the account-to-account transaction having an asset exchange, an issuance of an IoU, and the total economic total economic impact within the edge of connected accounts. Evaluation module 112 may create a self-sovereign credit token issuance to facilitate an account-to-account lending and creation of a digital credit market. Evaluation module 112 may incorporate all digital entities involved in the decentralized finance.

In one or more embodiments, evaluation module 112 is configured to evaluate, based on the digital interaction, a potential future earning of a fungible token and a non-fungible token. Evaluation module 112 may evaluate the potential future earning of a nontransferable non-fungible token. Evaluation module 112 may evaluate digital potential of future earnings such as fungible tokens, utility tokens and non-fungible tokens. Evaluation module 112 may evaluate the potential earnings and value of nontransferable non-fungible tokens such as a health care record, a driving history and a user-based insurance. In an example, non-fungible tokens may include intellect property, patents, trademarks, brands, trust, and other suitable non-fungible tokens. Non-fungible tokens may include assets with a future maturity date, e.g., interests from a saving account.

In one or more embodiments, issuance module 114 is configured to provide a criterion to generate a self-sovereign, self-issued credit token that is embedded with a credit worthiness of the self-sovereign, self-issued credit token, based on the total economic impact and the potential future earnings. Issuance module 114 may issue the self-sovereign, self-issued credit token based on the total economic impact and the potential future earnings. Issuance module 114 may append a credential to the self-sovereign, self-issued credit token that includes a ratio of the total economic impact and the potential future earnings. Issuance module 114 may update a specific chain and asset inventory 106 to reflect a credit upon a transaction validation and the docket credential updated on a transaction finality. In response to determining that the total economic impact is positive, issuance module 114 may issue a self-sovereign, self-issued credit token implying sufficient collateral and credit worthiness. In response to determining that the total economic impact is negative, issuance module 114 may issue a self-sovereign, self-issued credit token based on the potential future earnings factored in to induce a notion on ability to repay against a credit credential. Issuance module 114 may integrate and evaluate existing sources and history from various networks in generation of a new asset for a user. Issuance module 114 may not issue a self-sovereign, self-issued credit token if the total economic impact and the potential future earnings are negative. Issuance module 114 may issue on a specific chain. Issuance module 114 may update an asset class categorization and asset inventory to reflect the credit upon the transaction validation and the docket credential is updated on a transaction finality. Issuance module 114 may issue a self-sovereign credit token that provides a credential to the token issued. Issuance module 114 may provide transparent evaluation by computing the potential valuation, collateralization, potential future earning and total economic impact on personal creditworthiness. Issuance module 114 may focus on digital activities including the future earning potential of assets based on a user's finance history, spending and investment in a digital realm.

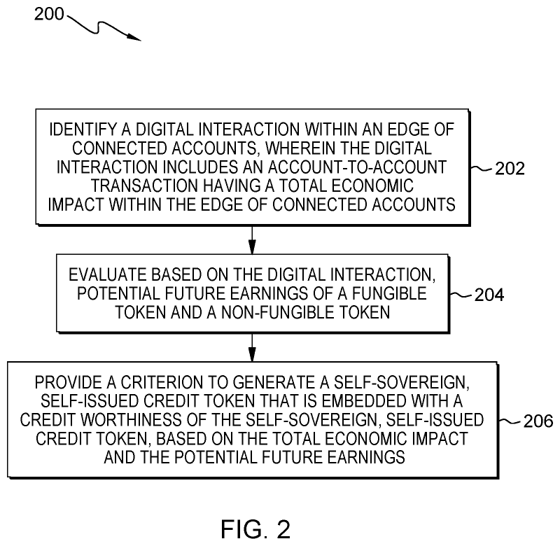

FIG. 2 is a flowchart 200 depicting operational steps of self-sovereign token issuance module 110 in accordance with an embodiment of the present disclosure.

Self-sovereign token issuance module 110 operates to identify a digital interaction within an edge of connected accounts, wherein the digital interaction includes an account-to-account transaction having a total economic impact within the edge of connected accounts. Self-sovereign token issuance module 110 operates to evaluate, based on the digital interaction, potential future earnings of a fungible token and a non-fungible token. Self-sovereign token issuance module 110 operates to provide a criterion to generate a self-sovereign, self-issued credit token that is embedded with a credit worthiness of the self-sovereign, self-issued credit token, based on the total economic impact and the potential future earnings.

In step 202, self-sovereign token issuance module 110 identifies a digital interaction within an edge of connected accounts. The digital interaction may include an account-to-account transaction having a total economic impact within the edge of connected accounts. A total economic impact may be potential effects of investments across cost, benefits, flexibility, and risk. A total economic impact may provide a cost and benefit analysis that may incorporate an evaluation of future technology and business flexibility and associated risk. Self-sovereign token issuance module 110 may take stock of all digital interactions including the account-to-account transaction having an asset exchange, an issuance of an IoU, and the total economic total economic impact within the edge of connected accounts. Self-sovereign token issuance module 110 may create a self-sovereign credit token issuance to facilitate an account-to-account lending and creation of a digital credit market. Self-sovereign token issuance module 110 may incorporate all digital entities involved in the decentralized finance. Self-sovereign token issuance module 110 may issue a self-sovereign credit token that provides a credential to the token issued. Self-sovereign token issuance module 110 may provide transparent evaluation by computing the potential valuation, collateralization, potential future earning and total economic impact on personal creditworthiness. Self-sovereign token issuance module 110 may focus on digital activities including the future earning potential of assets based on a user's finance history, spending and investment in a digital realm.

In step 204, self-sovereign token issuance module 110 evaluates, based on the digital interaction, a potential future earning of a fungible token and a non-fungible token. In an example, the non-fungible token may be selected from a group consisting of: intellectual property, patent, trademark, trade secret, brand name, artwork, article, stock, and trust. In another example, the non-fungible token may be any other suitable non-fungible tokens. Self-sovereign token issuance module 110 may evaluate the potential future earning of a nontransferable non-fungible token. In an example, the nontransferable non-fungible token may include a health care record, a driving history, and a user-based insurance. In another example, the nontransferable non-fungible token may be any other suitable nontransferable non-fungible tokens. Self-sovereign token issuance module 110 may evaluate digital potential of future earnings such as fungible tokens, utility tokens and non-fungible tokens. Self-sovereign token issuance module 110 may evaluate the potential earnings and value of nontransferable non-fungible tokens such as a health care record, a driving history and a user-based insurance. In an example, non-fungible tokens may include intellect property, patents, trademarks, brands, trust, and other suitable non-fungible tokens. Non-fungible tokens may include assets with a future maturity date, e.g., interests from a saving account.

In step 206, self-sovereign token issuance module 110 provides a criterion to generate a self-sovereign, self-issued credit token that is embedded with a credit worthiness of the self-sovereign, self-issued credit token, based on the total economic impact and the potential future earnings. Self-sovereign token issuance module 110 may issue the self-sovereign, self-issued credit token based on the total economic impact and the potential future earnings. Self-sovereign token issuance module 110 may append a credential to the self-sovereign, self-issued credit token that includes a ratio of the total economic impact and the potential future earnings. Self-sovereign token issuance module 110 may update a specific chain and asset inventory 106 to reflect a credit upon a transaction validation and the docket credential updated on a transaction finality. In response to determining that the total economic impact is positive, self-sovereign token issuance module 110 may issue a self-sovereign, self-issued credit token implying sufficient collateral and credit worthiness. In response to determining that the total economic impact is negative, self-sovereign token issuance module 110 may issue a self-sovereign, self-issued credit token based on the potential future earnings factored in to induce a notion on ability to repay against a credit credential. Self-sovereign token issuance module 110 may integrate and evaluate existing sources and history from various networks in generation of a new asset for a user. Self-sovereign token issuance module 110 may not issue a self-sovereign, self-issued credit token if the total economic impact and the potential future earnings are negative. Self-sovereign token issuance module 110 may issue on a specific chain. Self-sovereign token issuance module 110 may update an asset class categorization and asset inventory to reflect the credit upon the transaction validation and the docket credential is updated on a transaction finality.

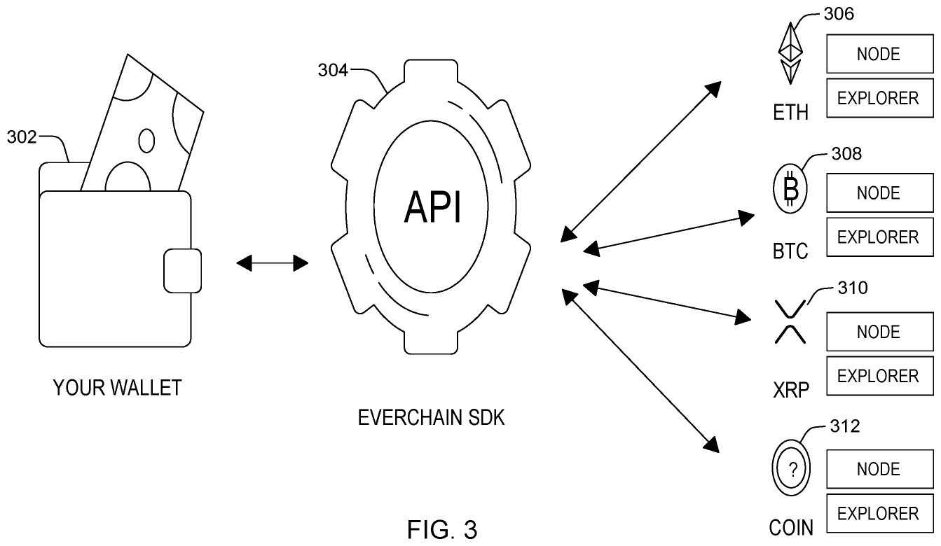

FIG. 3 illustrates an exemplary wallet on various blockchains of functional diagram of self-sovereign token issuance module 110, in accordance with an embodiment of the present disclosure.

In the example of FIG. 3, wallet 302 can be a representation of a custodial or non-custodial account on a blockchain network. For example, wallet 302 can be a custodian wallet (e.g., hosted by a third party). In another example, wallet 302 can be a non-custodial wallet (e.g., hosted by an account holder that can be an individual or an institution). Wallet 302 may be a part of a blockchain network, with access to multiple blockchain networks through application programming interface 304. In the example, the blockchain networks may include accessing to Ether (ETH) 306, Bitcoin (BTC) 308, Ripple (XRP) 310 and coin 312. In an example, multiple wallets can be represented as a single wallet utilizing asset classification module 104 which can be a multi-wallet asset classification and inventory modulator. Asset classification module 104 may provide representation as a single wallet, which function is to ensure registration of all wallets in blockchain networks 306, 308, 310, 312.

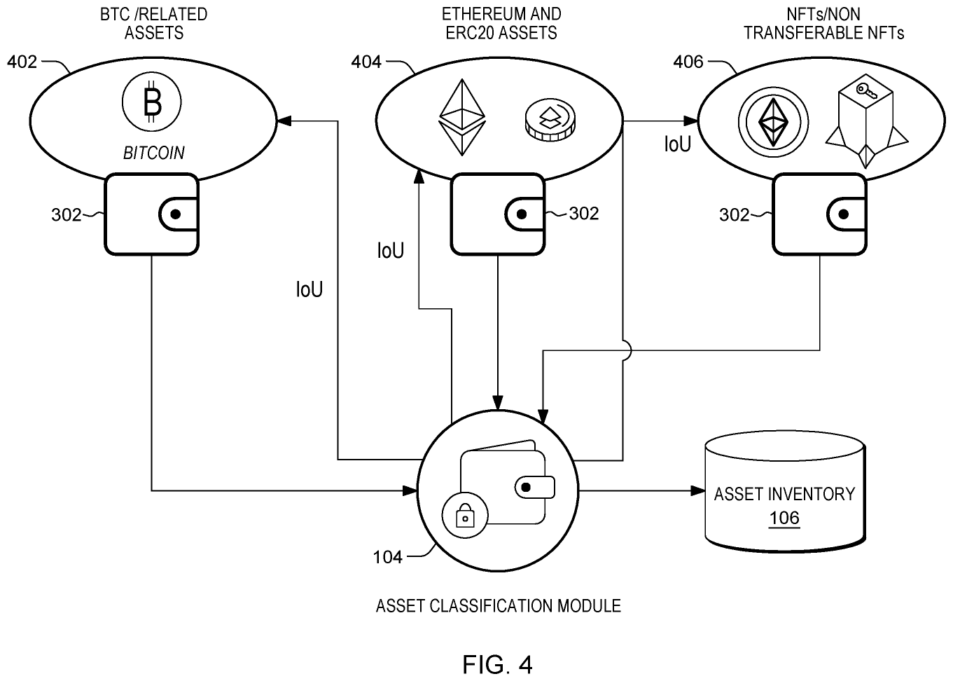

FIG. 4 illustrates an exemplary functional diagram of asset classification module 104, in accordance with an embodiment of the present disclosure.

In the example of FIG. 4, asset classification module 104 may provide an inventory of asset classes in asset inventory 106. For example, the asset classes may include BTC and BTC related assets 402, Ethereum (e.g., ERC-20) assets 404, and non-fungible tokens (including non-transferrable non-fungible tokens) 406. In another example, the asset classes may include other suitable assets. Asset classification module 104 may classify and provide a current list of all assets classes including previous issued IOUs, DeFi tokens, crypto native assets, utility coins, and lending and IoU of other accounts. The asset may also include fungible tokens, utility tokens, and non-fungible tokens, and other non-transferable non-fungible tokens. Asset classification module 104 may provide access to evaluation modules (e.g., a third-party service such as an exchange or a DeFi market data provider). Asset classification module 104 may provide representation as a single wallet, which function is to ensure registration of all wallets 302 in all blockchain networks. In an example, multiple wallets 302 can be represented as a single wallet utilizing asset classification module 104 which can be a multi-wallet asset classification and inventory modulator.

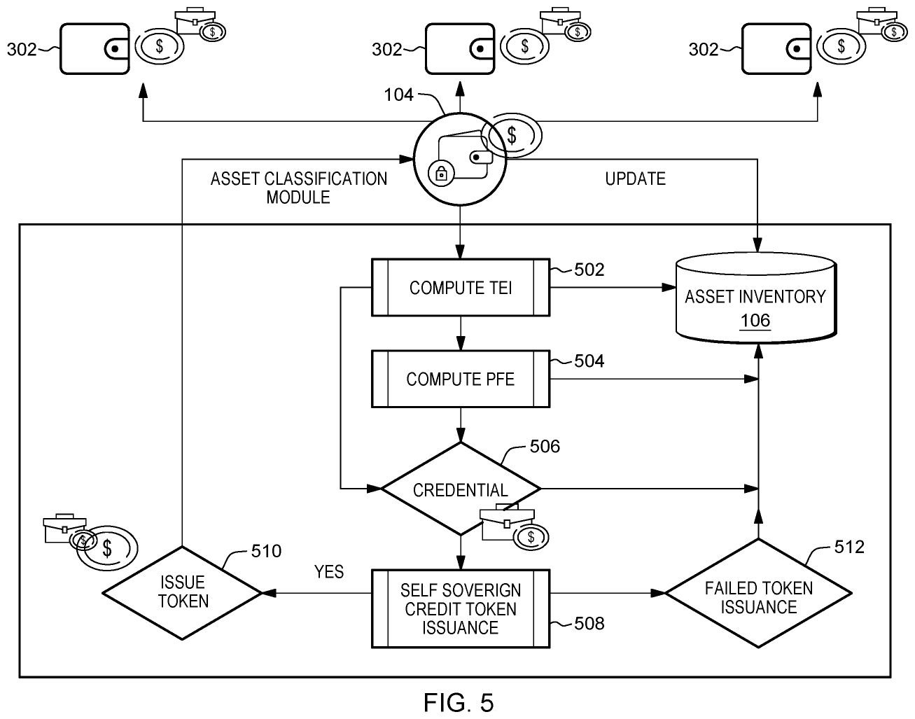

FIG. 5 illustrates an exemplary functional diagram of self-sovereign token issuance module 110, in accordance with an embodiment of the present disclosure.

In the example of FIG. 5, self-sovereign token issuance module 110 may identify a digital interaction within an edge of connected accounts. The digital interaction may include an account-to-account transaction having a total economic impact within the edge of connected accounts. Self-sovereign token issuance module 110 may take stock of all digital interactions including the account-to-account transaction having an asset exchange, an issuance of an IoU, and the total economic impact within the edge of connected accounts. Self-sovereign token issuance module 110 may create a self-sovereign credit token issuance to facilitate an account-to-account lending and creation of a digital credit market. Self-sovereign token issuance module 110 may incorporate all digital entities involved in the decentralized finance. Self-sovereign token issuance module 110 may issue a self-sovereign credit token that provides a credential to the token issued. Self-sovereign token issuance module 110 may provide transparent evaluation by computing the potential valuation, collateralization, potential future earning and total economic impact on personal creditworthiness.

In block 502, self-sovereign token issuance module 110 may evaluate and compute the total economic impact. In block 504, self-sovereign token issuance module 110 may evaluate and compute, based on the digital interaction, a potential future earning of a fungible token and a non-fungible token. Self-sovereign token issuance module 110 may evaluate the potential future earning of a nontransferable non-fungible token. In block 506, self-sovereign token issuance module 110 may provide a criterion to generate a self-sovereign, self-issued credit token that is embedded with a credit worthiness of the self-sovereign, self-issued credit token, based on the total economic impact and the potential future earnings. In block 508, self-sovereign token issuance module 110 may issue the self-sovereign, self-issued credit token based on the total economic impact and the potential future earnings. Self-sovereign token issuance module 110 may append a credential to the self-sovereign, self-issued credit token that includes a ratio of the total economic impact and the potential future earnings. Self-sovereign token issuance module 110 may update a specific chain and asset inventory 106 to reflect a credit upon a transaction validation and the docket credential updated on a transaction finality. In response to determining that the total economic impact is positive, in block 510, self-sovereign token issuance module 110 may issue a self-sovereign, self-issued credit token implying sufficient collateral and credit worthiness. In response to determining that the total economic impact is negative, in block 510, self-sovereign token issuance module 110 may issue a self-sovereign, self-issued credit token based on the potential future earnings factored in to induce a notion on ability to repay against a credit credential. Self-sovereign token issuance module 110 may integrate and evaluate existing sources and history from various networks in generation of a new asset for a user. In block 512, self-sovereign token issuance module 110 may not issue a self-sovereign, self-issued credit token if the total economic impact and the potential future earnings are negative.

FIG. 6 depicts a block diagram 600 of components of computing device 102 in accordance with an illustrative embodiment of the present disclosure. It should be appreciated that FIG. 6 provides only an illustration of one implementation and does not imply any limitations with regard to the environments in which different embodiments may be implemented. Many modifications to the depicted environment may be made.

Computing device 102 may include communications fabric 602, which provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

Self-sovereign token issuance module 110 may be stored in persistent storage 608 and in memory 606 for execution by one or more of the respective computer processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Self-sovereign token issuance module 110 may be downloaded to persistent storage 608 through communications unit 610.

I/O interface(s) 612 allows for input and output of data with other devices that may be connected to computing device 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., self-sovereign token issuance module 110 can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
identifying, by one or more processors, a digital interaction within an edge of connected accounts, wherein the digital interaction includes an account-to-account transaction having a total economic impact within the edge of connected accounts;
evaluating, by one or more processors, based on the digital interaction, potential future earnings of a fungible token and a non-fungible token; and
providing, by one or more processors, a criterion to generate a self-sovereign, self-issued credit token that is embedded with a credit worthiness of the self-sovereign, self-issued credit token, based on the total economic impact and the potential future earnings.

2. The computer-implemented method of claim 1, wherein identifying the digital interaction comprises taking stock of digital interactions including the account-to-account transaction having an asset exchange, an issuance of an IoU, and the total economic total economic impact within the edge of connected accounts.

3. The computer-implemented method of claim 1, further comprising evaluating the potential future earnings of a nontransferable non-fungible token, wherein the nontransferable non-fungible token includes a health care record, a driving history, and a user-based insurance.

4. The computer-implemented method of claim 1, wherein the non-fungible token is selected from a group consisting of: intellectual property, patent, trademark, trade secret, brand name, artwork, article, stock, and trust.

5. The computer-implemented method of claim 1, further comprising:
issuing the self-sovereign, self-issued credit token based on the total economic impact and the potential future earnings;
appending a docket credential to the self-sovereign, self-issued credit token that includes a ratio of the total economic impact and the potential future earnings; and
updating a specific chain and an asset inventory to reflect a credit upon a transaction validation and the docket credential updated on a transaction finality.

6. The computer-implemented method of claim 1, further comprising:
in response to determining that the total economic impact is positive, issuing the self-sovereign, self-issued credit token implying sufficient collateral and credit worthiness.

7. The computer-implemented method of claim 1, further comprising:
in response to determining that the total economic impact is negative, issuing the self-sovereign, self-issued credit token based on the potential future earnings factored in to induce a notion on ability to repay against a credit credential.

8. A computer program product comprising:
one or more computer readable storage media, and program instructions collectively stored on the one or more computer readable storage media, the program instructions comprising:
program instructions to identify a digital interaction within an edge of connected accounts, wherein the digital interaction includes an account-to-account transaction having a total economic impact within the edge of connected accounts;
program instructions to evaluate, based on the digital interaction, potential future earnings of a fungible token and a non-fungible token; and
program instructions to provide, a criterion to generate a self-sovereign, self-issued credit token that is embedded with a credit worthiness of the self-sovereign, self-issued credit token, based on the total economic impact and the potential future earnings.

9. The computer program product of claim 8, wherein program instructions to identify the digital interaction comprise program instructions to take stock of digital interactions including the account-to-account transaction having an asset exchange, an issuance of an IoU, and the total economic total economic impact within the edge of connected accounts.

10. The computer program product of claim 8, further comprising program instructions to evaluate the potential future earnings of a nontransferable non-fungible token, wherein the nontransferable non-fungible token includes a health care record, a driving history, and a user-based insurance.

11. The computer program product of claim 8, wherein the non-fungible token is selected from a group consisting of: intellectual property, patent, trademark, trade secret, brand name, artwork, article, stock, and trust.

12. The computer program product of claim 8, further comprising:
program instructions to issue the self-sovereign, self-issued credit token based on the total economic impact and the potential future earnings;
program instructions to append a docket credential to the self-sovereign, self-issued credit token that includes a ratio of the total economic impact and the potential future earnings; and
program instructions to update a specific chain and an asset inventory to reflect a credit upon a transaction validation and the docket credential updated on a transaction finality.

13. The computer program product of claim 8, further comprising:
program instructions to, in response to determining that the total economic impact is positive, issue the self-sovereign, self-issued credit token implying sufficient collateral and credit worthiness.

14. The computer program product of claim 8, further comprising:
program instructions to, in response to determining that the total economic impact is negative, issue the self-sovereign, self-issued credit token based on the potential future earnings factored in to induce a notion on ability to repay against a credit credential.

15. A computer system comprising:
one or more computer processors, one or more computer readable storage media, and program instructions stored on the one or more computer readable storage media for execution by at least one of the one or more computer processors, the program instructions comprising:
program instructions to identify a digital interaction within an edge of connected accounts, wherein the digital interaction includes an account-to-account transaction having a total economic impact within the edge of connected accounts;
program instructions to evaluate, based on the digital interaction, potential future earnings of a fungible token and a non-fungible token; and
program instructions to provide, a criterion to generate a self-sovereign, self-issued credit token that is embedded with a credit worthiness of the self-sovereign, self-issued credit token, based on the total economic impact and the potential future earnings.

16. The computer system of claim 15, wherein program instructions to identify the digital interaction comprise program instructions to take stock of digital interactions including the account-to-account transaction having an asset exchange, an issuance of an IoU, and the total economic total economic impact within the edge of connected accounts.

17. The computer system of claim 15, further comprising program instructions to evaluate the potential future earnings of a nontransferable non-fungible token, wherein the nontransferable non-fungible token includes a health care record, a driving history, and a user-based insurance.

18. The computer system of claim 15, wherein the non-fungible token is selected from a group consisting of: intellectual property, patent, trademark, trade secret, brand name, artwork, article, stock, and trust.

19. The computer system of claim 15, further comprising:
program instructions to issue the self-sovereign, self-issued credit token based on the total economic impact and the potential future earnings;
program instructions to append a docket credential to the self-sovereign, self-issued credit token that includes a ratio of the total economic impact and the potential future earnings; and
program instructions to update a specific chain and an asset inventory to reflect a credit upon a transaction validation and the docket credential updated on a transaction finality.

20. The computer system of claim 15, further comprising:
program instructions to, in response to determining that the total economic impact is positive, issue the self-sovereign, self-issued credit token implying sufficient collateral and credit worthiness.
